(19) United States
(12) Patent Application Publication
(10) Pub. No.: US 2004/0061302 A1
(43) Pub. Date: Apr. 1, 2004

(54) Techniques for making carbon fiber bicycle frames

(75) Inventor: Robert Parlee, Essex, MA (US)

Correspondence Address: GORDON E NELSON, PATENT ATTORNEY, PC, 57 CENTRAL ST, PO BOX 782, ROWLEY, MA, 01969, US

(73) Assignee: Parlee Cycles, Inc.

(21) Appl. No.: 10/671,078

(22) Filed: Sep. 25, 2003

Related U.S. Application Data
(60) Provisional application No. 60/413,346, filed on Sep. 25, 2002.

(51) Int. Cl. B62K 1/00

(52) U.S. Cl. 280/274

(57) ABSTRACT

Techniques for making carbon fiber bicycle frames. The techniques include techniques for making a chain stay-seat stay structure that includes carbon fiber tubes that are differentially stiff and techniques for making carbon fiber lugs for the frames. One of the techniques for making the chain stay-seat stay structure includes a wish bone seat stay in which the root tube of the seat stay has an oval cross section, so that the root tube is stiffer in the horizontal direction than it is in the vertical direction. Another of the techniques is a dual seat stay chain stay-seat stay structure in which the tubes of the structure have lay-ups such that the tubes are stiffer when bent than when twisted.

The techniques for making carbon fiber lugs employ expandable elements enclosed in a mold. In one of the techniques, the mold is a captured silicon mold and when the lug is cured, the captured silicon expands and forces the carbon fibers and matrix making up the lug against the tubes joined by the lug. In another of the techniques, a syntactic foam is applied between layers of the carbon fibers. The foam expands when the lug is cured and forces the carbon fibers and matrix against both the mold and the tubes joined by the lug. In either case, the mold may be formed such that the lug tapers towards the tubes.

### CROSS REFERENCES TO RELATED APPLICATIONS

The present patent application claims priority from U.S. provisional patent application No. 60/413,346, Robert Parlee, Frame for a high-performance bicycle, filed Nov. 25, 2002.

### BACKGROUND OF THE INVENTION

1. Field of the Invention

The invention has generally to do with bicycle frames and more particularly to do with double diamond bicycle frames made using carbon fiber tubes.

2. Description of related art For the last century, most bicycles have had the kind of frame shown at 101 in FIG. 1. Frame 101 is what is termed a double diamondframe, because of the shape made by its members. The members of a double diamond frame are tubes. They are named as follows: top tube 103, seat tube 105, down tube 107, head tube 113, seat stays 109, and chain stays 111. The tubes have been made from many materials: most commonly steel, but more recently aluminum and titanium, and most recently, carbon fiber. In many double diamond frames, the tubes are joined by lugs. The lugs are named according to their positions: the lug 117 that joins head tube 113, top tube 103, and down tube 107 is called the head lug; the lug 115 that joins the seat stays 109, seat tube 105, and top tube 103 is called the seat lug; the lug 119 that joins seat tube 105, the chain stays 111, and down tube 107 is termed the bottom bracket lug. In the following, the structure formed by the chain stays 111 and the seat stays 109 will be termed the chain stay-seat stay structure. For a general discussion of double diamond frame construction, see Sheldon Brown, Frame materials for the touring cyclist, found on Sep. 19, 2003 at http://www.sheldonbrown.com/frame_materials.html.

The goal in designing a double diamond frame is to achieve a frame that is light, stiff, and durable. The need for lightness and durability are obvious; the frame needs to be stiff so that the effort the rider puts into pedaling is transmitted to the rear wheel, rather than being consumed in flexing the frame members. A problem with really stiff frames is that they are uncomfortable: a frame that efficiently transmits power to the rear wheel is equally efficient at transmitting the shocks caused by bumps in the road to the rider.

One object of the frame making techniques that are the subject of the present patent application is to provide double diamond frames that increase rider comfort while retaining efficient transmission of power to the rear wheel.

Another object is to provide improved techniques for making lugs for carbon fiber frames. With frames that are made of metal, the lugs are also made of metal and the tubes are attached to the lugs using standard metal-bonding techniques. Metal may be used for the lugs in carbon fiber frames, but stronger frames result if the lugs are also made from carbon fiber. Makers of carbon fiber frames have had difficulty making lugs that were strong, had a neat appearance, and did not require extensive finishing after they were made.

### SUMMARY OF THE INVENTION

The objective of providing a double diamond frame with increased rider comfort is achieved by a double diamond bicycle frame which has a seat stay-chain stay structure which includes at least one carbon fiber tube that is differentially stiff with regard to bending and twisting. The differential stiffness is achieved by using a lay-up for the tube which gives greater stiffness with regard to bending than with regard to twisting. In one aspect of the invention, the seat stay-chain stay structure is a dual seat stay structure in which both the chain stays and the seat stays are differentially stiff with regard to bending and twisting. In another aspect of the invention, the seat stay-chain stay structure has a wishbone seat stay and differentially stiff chain stays. In still another aspect, the wishbone seat stay has a handle which has a cross section which renders it less stiff in a vertical direction than in a horizontal direction.

The objective of providing improved lug construction techniques is achieved by making the lugs by applying a lay-up of at least carbon fibers and a matrix material around the joint, applying a mold to the tubes and laid up fibers and matrix material, and curing the lug in the mold, the cure including expansion of an element enclosed by the mold. In one aspect of the invention, the expanding element is a component of the mold which expands to urge the lay-up against the tubes; in another aspect of the invention, the element is a component of the lay-up which expands to urge the lay-up against the tubes and the mold. In another aspect, the mold has a form such that the lugs taper towards the tubes as the distance from the joint increases.

Other objects and advantages will be apparent to those skilled in the arts to which the invention pertains upon perusal of the following Detailed Description and drawing, wherein:

### BRIEF DESCRIPTION OF THE DRAWING

FIG. 1 is a schematic illustration of a double diamond frame;

FIG. 2 shows a double diamond frame that incorporates the invention and has dual seat stays;

FIG. 3 is a specification of the lay-ups for the carbon fiber tubes of the frame of FIG. 2;

FIG. 4 shows a double diamond frame that incorporates the invention and has a wishbone seat stay;

FIG. 5 is a detailed drawing of the wishbone seat stay;

FIG. 6 shows a first technique for making the lugs;

FIG. 7 shows a second technique for making the lugs;

FIG. 8 shows a mold used for making tapered lugs;

FIG. 9 is a first detail of the lay-up of a lug; and

FIG. 10 is a second detail of the lay-up of a lug.

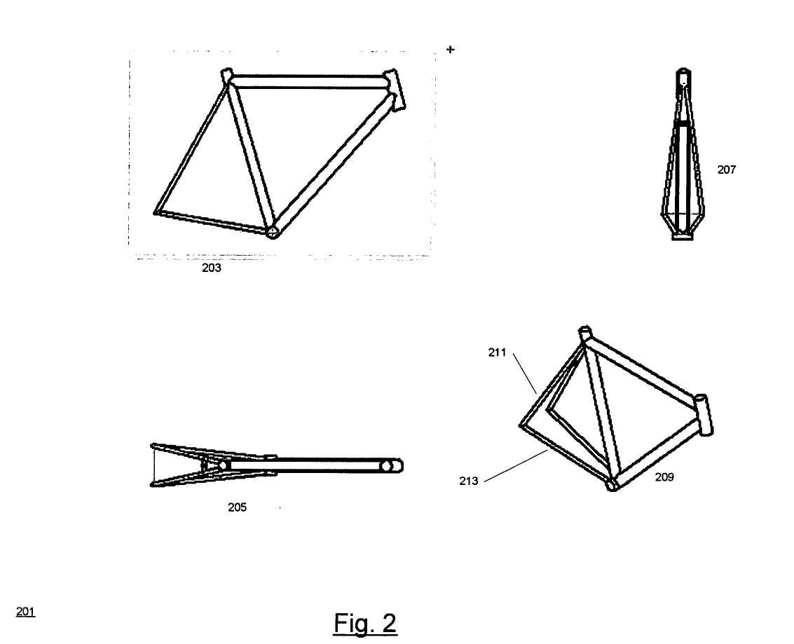

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION

The following Detailed Description will first describe techniques used in a diamond frame with standard seat stays to increase rider comfort while retaining efficiency, will then describe techniques to achieve the same end in a double diamond frame with wishbone seat stays, and will finally describe techniques for making lugs.

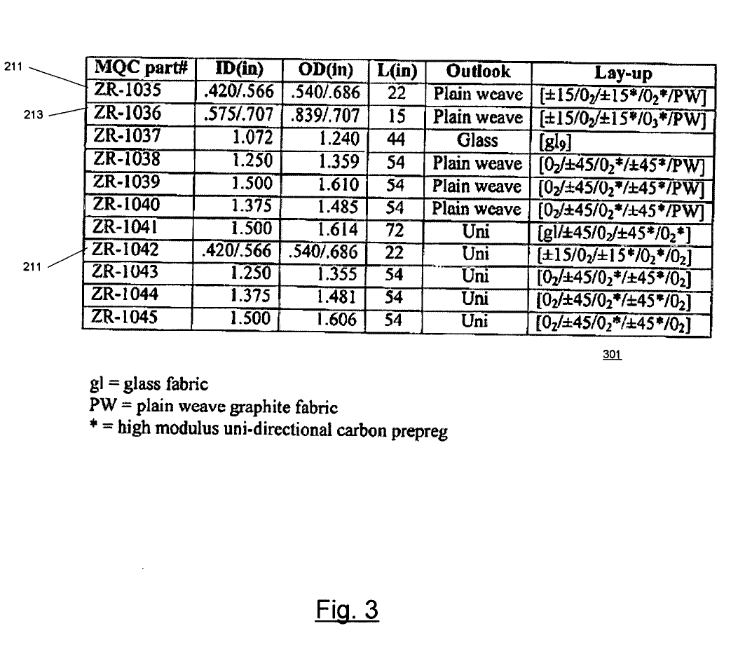

A Double Diamond Frame Having a Seat Stay-Chain Stay Structure with Differential Stiffness: FIGS. 2 and 3

FIG. 2 is a drawing of a carbon fiber tube double diamond frame 201 that has a seat stay-chain stay structure with differential stiffness, ie., the structure includes a member or members which are stiffer with regard to one kind of force than they are with regard to another. In FIG. 2, the seat stay-chain stay structure uses tubes for the seat stays and chain stays which are stiffer against bending forces than they are against twisting forces. They are thus stiffer against bending caused by the force applied by the pedals on the chain than they are against twisting caused by bumps in the road. Four views of frame 201 are provided: 203 is a side view, 205 is a top view, and 207 is a rear view. 209 is an isometric projection. The seat stay-chain stay structure is clearest in view 209; it is a dual seat stay structure, i.e., a separate seat stay 211 runs between the end of each chain stay 213 and the top of seat tube 105.

The differential stiffness in the seat stay-chain stay structure of FIG. 2 is achieved by the way in which the carbon fiber tubes are made. Carbon fiber tubes are made generally by laying up layers of fabric made of carbon fibers. Depending on the application, the fabric may be woven, may be made up of unidirectional carbon fibers, or may have fibers with varying orientations. The directions in which the fibers in the layer run are specified relative to the axis of the tube. Thus, fibers with 0° orientations run parallel to the axis, or along the tube and those with 90° orientations run around the tube perpendicularly to the axis. In frame 201, all of the tubes but seat stays 211 and chain stays 213 are laid up with the carbon fibers running either along the tube or at plus or minus 45° to the tube's axis. This lay-up pattern produces tubes that are equally stiff with regard to bending forces and twisting forces. The seat stays 211 and chain stays 213 are laid up with the carbon fibers running along the tube and at plus or minus 15° to the tube's access. They are thus stiffer with regard to the bending forces than they are with regard to the twisting forces. As is apparent from the above description, the relative degrees of stiffness of the tubes with regard to twisting and bending can in general be controlled by the angle of the fibers in the layers that do not run parallel to the axis of the tube. The stiffness of the members of the chain stay-seat stay structure with regard to twisting forces can be safely reduced relative to the stiffness relative to the bending forces because the chain stay-seat stay structure forms a pyramid and the sides of the pyramid support each other against the twisting forces.

FIG. 3 is a specification for the lay-up of the tubes in a preferred embodiment of frame 201. For most of the tubes, there are two part numbers: one for a version of the tube that has a plain weave carbon fiber outer layer, and one for a version that does not. Each entry specifies the part number, the ID and OD of the tube, its length, and the kind of outer layer it is to have. In the lay-up, specification, layers are separated by “/”, with the number indicating the angle of the fibers in the layer relative to the tube's axis and * indicating whether the layer is preimpregnated with the epoxy that serves to bind the layers together. Thus, seat stay 211, which has part number ZR-1035, is made of a layer of carbon fiber cloth whose fibers run at the 15° angles relative to the axis, a layer of unidirectional fiber that runs parallel to the axis, a preimpregnated layer of the cloth, a preimpregnated layer of unidirectional fiber, and a layer of plain weave graphite fabric.

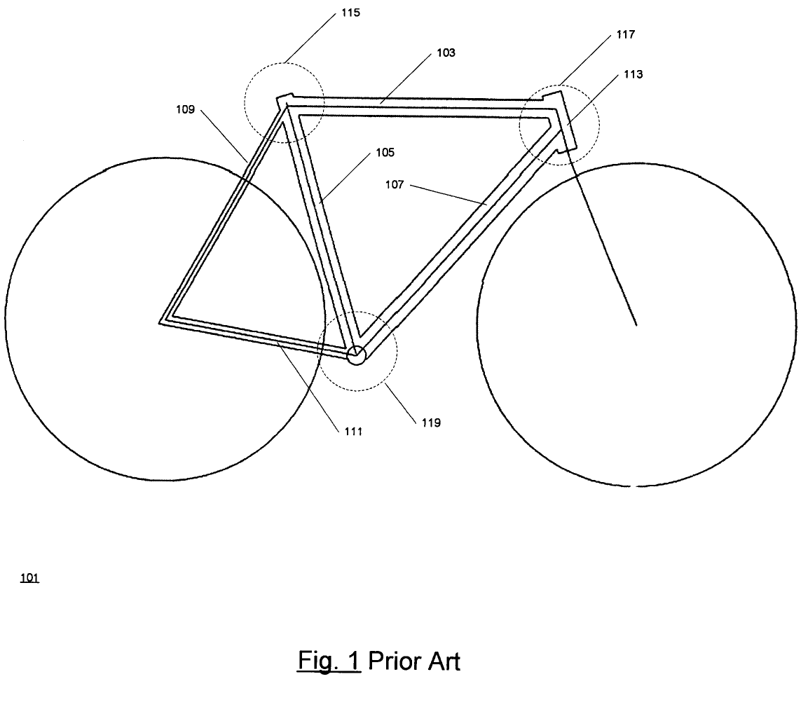

The relationship between the part numbers and the tubes of FIGS. 1 and 2 are as follows:

| Frame tube | Part number |
|---|---|
| Top tube 103 | 1040, 1044 |
| Seat tube 105 | 1039, 1045 |
| Down tube 107 | 1038, 1043 |
| Seat stay 109, 211 | 1035, 1042 |
| Chain stay 111, 213 | 1036 |

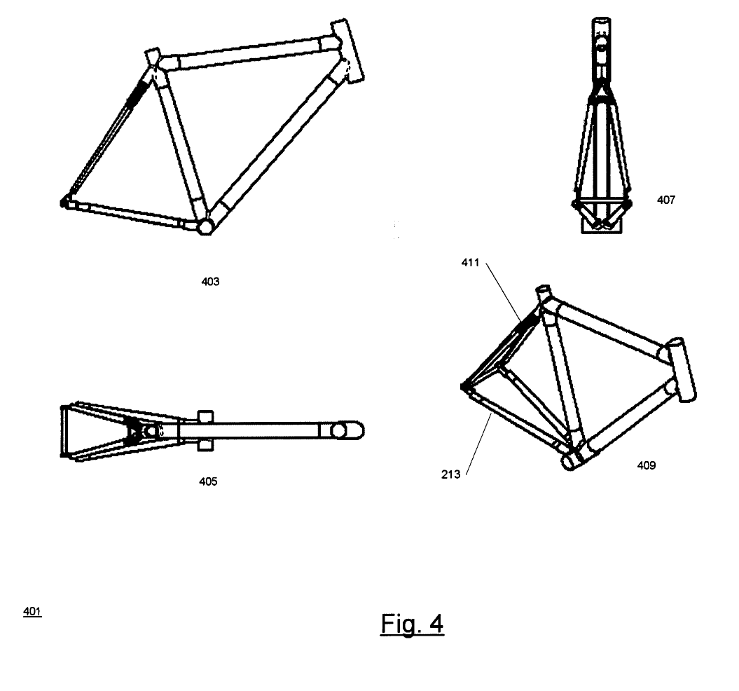

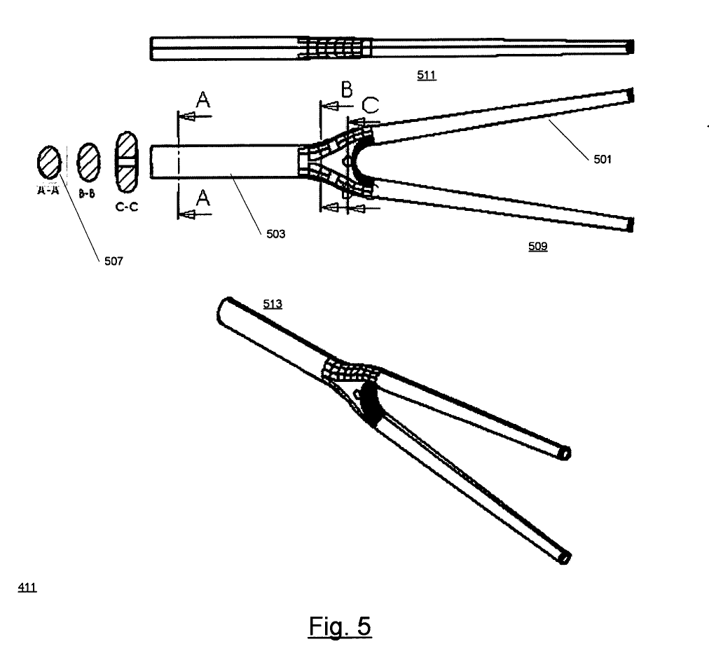

Using a Wish Bone Seat Stay to Achieve Differential Stiffness: FIGS. 4 and 5

Another version of a frame with differential stiffness in the chain stays and seat stays employs a wishbone seat stay. FIG. 4 is a drawing of this frame 401. Again there are presented a side view 403, a top view 405, a back view 407, and an isometric projection 409. Wishbone seat stay 411 is best seen in isometric projection 409. FIG. 5 presents a detail of wishbone seat stay 411, including a top view 509, a side view 511, and an isometric projection 513. Wishbone seat stay 411 is a single piece with two branches 501 and a “handle” 503. Handle 503 has an elliptical cross section, as shown at 507. Elliptical cross section 507 provides the “give” in the vertical direction that is required for rider comfort, so the lay-up of wishbone seat stay 411 in a preferred embodiment uses alternating layers 0/90 degree carbon and +/−45 degree carbon cloth and wrapped with an outside layer of 0/90 degree plain weave graphite fabric. If less stiffness is desired with regard to twisting, the 45° could be reduced to 22.5°, with the amount of reduction depending upon the amount of torsional stiffness desired in the wishbone. The chain stays used with the wishbone seat stay have the same lay-up as the chain stays used with dual seat stays.

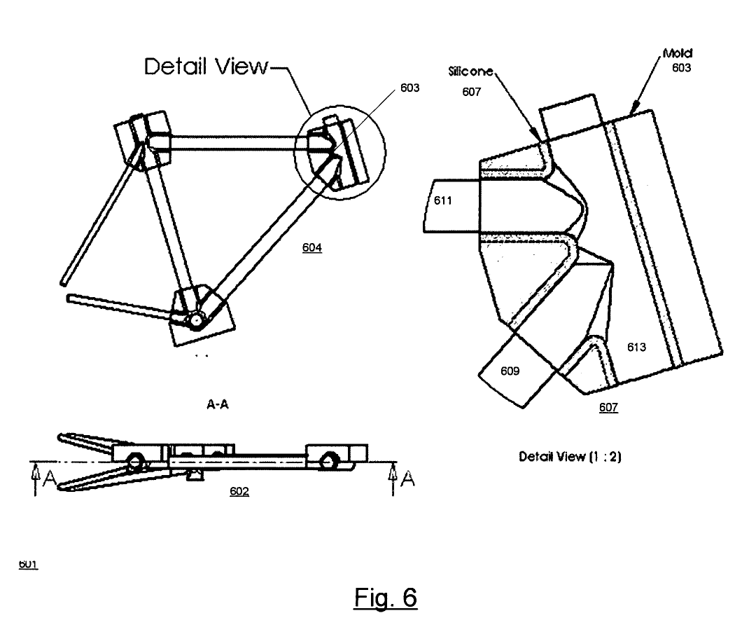

Construction of Lugs in Frames 201 and 401: FIGS. 6-8

In general, lugs are constructed in frames 201 and 401 as follows: at the points where the tubes of the frame come together, termed herein joints, the tubes are mitered to make intimate contact with each other. Pre-impregnated carbon fiber fabric is laid up around the joint to form a lug. The kind of fabric and the number of layers used depend on the particular lug and the size of the frame. The carbon fiber fabric is cut in a way that tends to eliminate seams and approximate a continuous fiber lay-up. A mold is then placed around the tubes and the lug and the lug is ramped up to a set temperature at a fixed rate, held at the set temperature, and then permitted to cool for a fixed period of time. This procedure cures the lug. As will be explained in more detail later, an expandable material either in the mold or in the lug expands to force the lay-up tightly against the frame and the mold. The expandable material compacts the carbon fiber fabric evenly throughout the lug. The use of the expandable material together with the pre-impregnated fabric prevents the occurrence of voids in the lugs. Such voids are a common cause of failure in carbon fiber structures. The mold may be of any material which can conduct the heat required for curing the lug. In a preferred embodiment, the molds are made of aluminum.

Making Lugs with a Captured Silicon Mold: FIG. 6

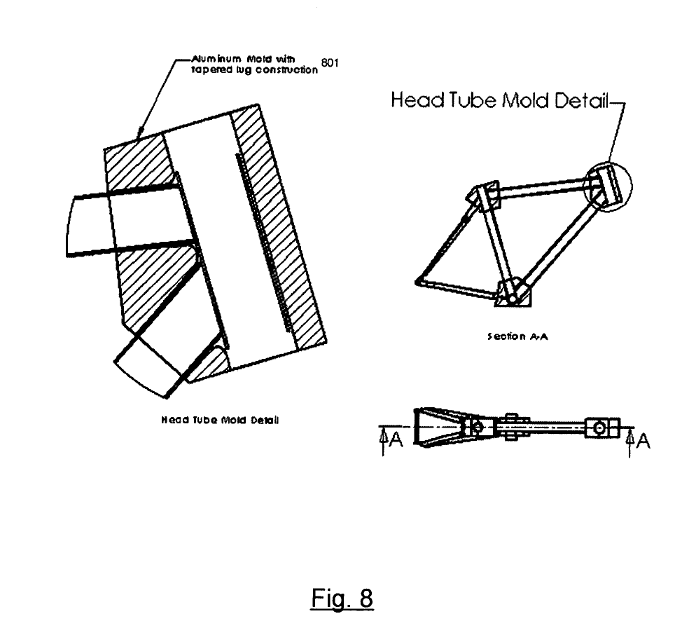

In one version of the process, shown in FIG. 6, the mold is a captured-silicon mold 603. A side view 604 and a top view 602 show a frame 201 with molds attached to each of the main joint areas; detailed view 606 shows a detail of mold 603 for the head lug 117. At 611 is shown the top tube, at 609 the down tube, and at 613 the header tube. Prior to being attached to frame 201, mold 603 is lined with silicone 607; during the curing process, silicon 607 expands to force the carbon fiber and epoxy that form the lay-up against the tubes. For this process, the details for curing the lugs are as follows: a ramp rate of 4 degrees a minute, an optimum temperature of 250 degrees, which is held for one hour, and a cooling period of 2 hours. In a refinement employed in the preferred embodiment, mold 603 is made so that as the end of the lug is approached, the lug tapers down to the tub. The taper improves the appearance of the lug and improves the distribution of stress along the tubes joined by the lugs and may also improve the riding qualities of the frame. A mold with this refinement is shown at 801 in FIG. 8.

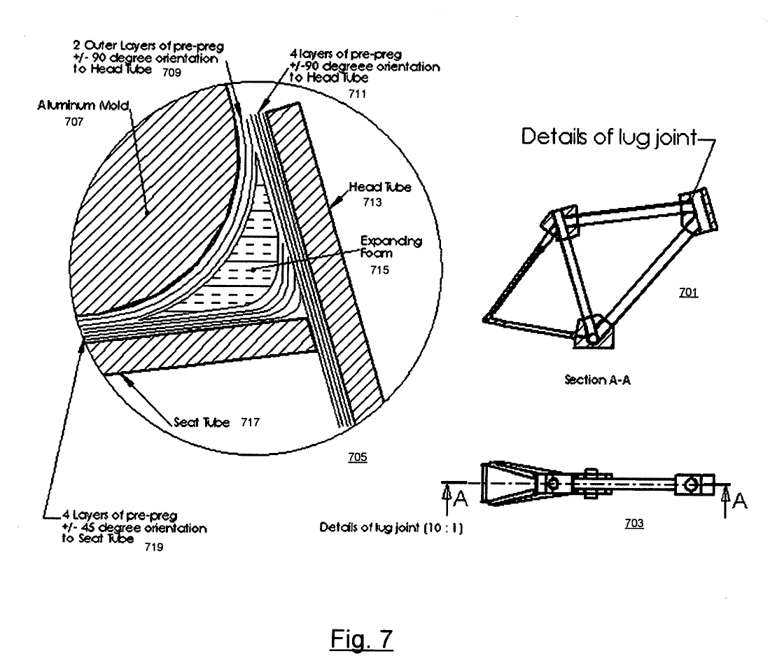

Making Lugs Using an Expanding Foam Layer in the Lay-Up: FIG. 7

A disadvantage of making lugs with a captured silicon mold is that the surface which forms the exterior of the lug is silicon layer 607. Silicon layer 607 is soft and adapts itself to irregularities in the surface of the lug lay-up. For example, if the last layer of the lay-up is cloth, the surface of the lug will retain the pattern of the fibers in the cloth. Extensive sanding is then required to obtain a smooth surface on the lug.

This problem is avoided by the technique shown in FIG. 7. Again, three views are shown: a side view of the frame with the molds attached, a top view of the frame, and a detail 705 of the joint and the mold for head lug 117. Only one side of seat tube 717 and head tube 713 are shown in detail 705. As shown there, the lug is made up of 6 layers of carbon-fiber cloth. An inner layer 711, 719 of four layers of fabric is laid down around seat tube 717 and head tube 713, with layer 719 being cut long to cover the seam between layer 719 and layer 711, then expanding syntactic foam 715 is placed in the crotches of the tubes, and finally an outer layer 709 of two more layers of fabric is laid down. Then aluminum mold 707 is placed around the lug and the lug is cured. During the curing process, expanding syntactic foam 715 expands and forces outer layer 709 against the surface of mold 707 and inner layer 711 against the tubes. Because the impregnated outer layer is forced against the hard smooth surface of mold 707, instead of against a soft layer of silicon, the surface of the finished lug is smooth and far less sanding is required. Other advantages of this technique are that it permits the lugs to have extensive fairings, which strengthens the joint and that more pressure is generated than with a captured silicon mold. The syntactic foam may of course also be used with a captured silicon mold. The curing parameters for this technique are as follows:

1. Heated at a ramp rate of 4 degrees Fahrenheit per minute to 250F

2. Cured at 250F for 1.5 hours.

3. Cooled for 2 hours

The syntactic foam employed in a preferred embodiment expands at temperatures that are the same as those used to cure the carbon fiber fabric, i.e., between 200 and 250° f. The particular synctactic foam employed in the preferred embodiment is Loctite SynSpand 9899, manufactured by Loctite Corporation 2850 Willow Pass Road PO Box 312 Bay Point, Calif. 94565-0031. This syntactic foam expands up to 650%.

Details of Laying up Lugs: FIGS. 7, 9 and 10

The lay-up of the lugs is done as follows in a preferred embodiment:

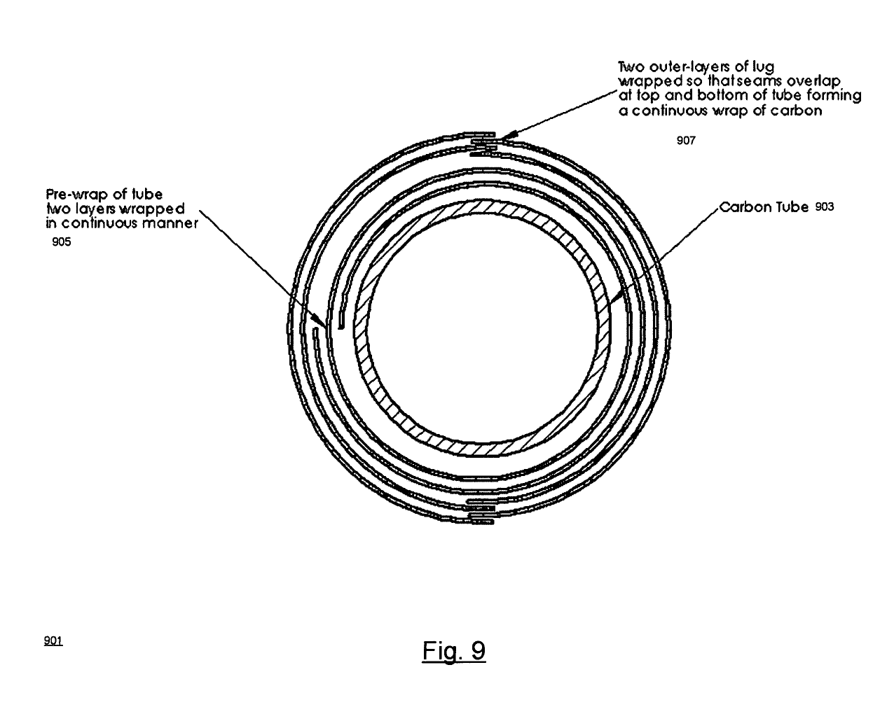

1. Pre-wrap the tube with 4-6 layers of uni-directional preimpregnated carbon fiber. Alternate the layers to create a +/−45 orientation to the tube. (this could also be accomplished using +/−45 woven cloth) These pre-wrapped pieces are applied around the tube starting at the side, or 3 o'clock position, and wound continually in two wraps, so as to cover the seam (FIG. 9, 905).

2. The pre-wrapped carbon at the tube ends extend beyond the tube end, and are wrapped partially around the tube they join to. This forms the initial lug.

3. A layer of syntactic foam is put into the crotch of the lug joints (FIG. 7, 715) (This step may be omitted when the captured silicone mold is used).

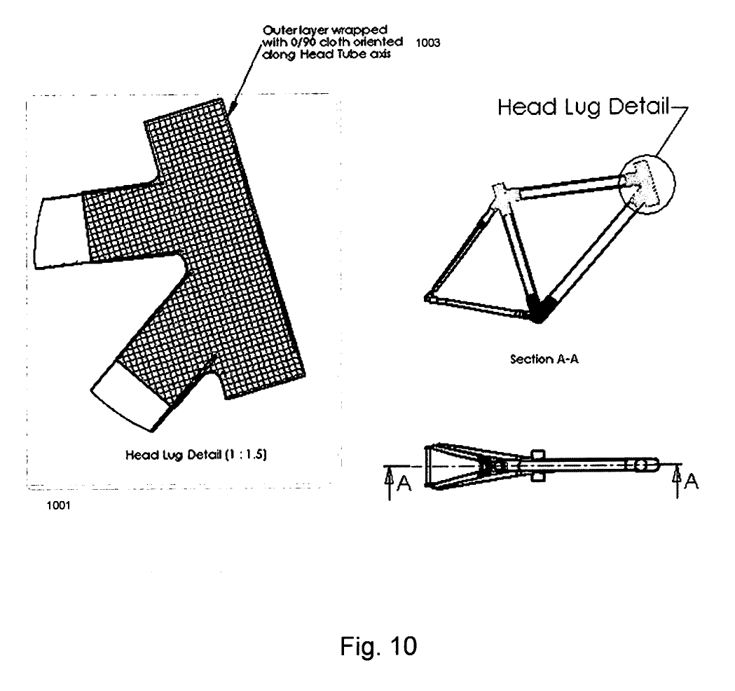

4. Pre-cut pieces of 0/90 preimpregnated cloth are then wrapped around the entire lug, with the 0/90 orientation along the “primary tube” axis. The primary tube is defined as the head tube at the head lug, the seat tube at the seat lug, and the seat tube at the bottom bracket lug (FIG. 10, 1001). The pre-cut outer layer pieces are designed such that all seams end at the tops and bottom of the tubes with a slight overlap creating continuous wrap of carbon around the tubes (FIG. 9, 907).

### CONCLUSION

The foregoing Detailed Description has disclosed how to make double diamond carbon fiber bicycle frames which combine stiffness with comfort and how to make improved lugs for such frames to those skilled in the arts of bicycle construction and has furthermore disclosed the best modes presently known to the inventors of practicing their inventions. It will be immediately apparent to those skilled in the arts of bicycle construction that the principles of the invention may be implemented in ways other than those disclosed herein; for example, the differential stiffness with regard to twisting and bending which is characteristic of the tubes used in the chain stay-seat stay structures built according to the principles disclosed herein may be achieved in ways other than by using the particular lay-ups disclosed herein; similarly, the use of an expanding element inside the mold to ensure that no voids arise in the lug is not limited to the lug lay-ups or the molds presently employed by the inventors or to the materials used to provide the expansion. Thus, for all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

What is claimed is:

1. A double diamond bicycle frame comprising:
a top tube;
a seat tube;
a down tube;
a head tube; and
a seat stay-chain stay structure which includes at least one differentially stiff carbon fiber tube that is differentially stiff with regard to bending and twisting.

2. The double diamond bicycle frame set forth in claim 1 wherein:
the at least one differentially stiff carbon fiber tube is made using a lay-up which gives greater stiffness with regard to bending than with regard to twisting.

3. The double diamond bicycle frame set forth in claim 1 wherein:
the seat stay-chain stay structure includes dual seat stays; and
both the dual seat stays and the chain stays are made of carbon fiber tubes that are stiffer with regard to bending than with regard to twisting.

4. The double diamond bicycle frame set forth in claim 3 wherein:
the dual seat stays and the chain stays are made using lay-ups which give greater stiffness with regard to bending than with regard to twisting.

5. The double diamond bicycle frame set forth in claim 1 wherein:
the seat stay-chain stay structure includes a wishbone seat stay; and
the chain stays are carbon fiber tubes made using lay-ups which give greater stiffness with regard to bending than with regard to twisting.

6. The double diamond bicycle frame set forth in claim 5 wherein:
the handle of the wishbone seat stay is a carbon fiber tube whose cross section is greater in a horizontal direction than in a vertical direction.

7. A bicycle frame comprising:
a plurality of carbon fiber tubes joined at joints; and
one or more lugs on the joints, a lug being made by
making a lay-up of at least carbon fibers and a matrix material around the joint,
applying a mold to the tubes and laid-up fibers and matrix material, and
curing the lug in the mold, the cure including expansion of an element enclosed by the mold.

8. The bicycle frame set forth in claim 7 wherein:
the element is a component of the mold which expands to urge the lay-up against the tubes.

9. The bicycle frame set forth in claim 7 wherein:
the element is a component of the lay-up which expands to urge the lay-up against the tubes and the mold.

10. The bicycle frame set forth in claim 7 wherein:
the mold has a form such that the lugs taper towards the tubes as the distance from the joint increases.

11. A seat stay-chain stay structure for a bicycle frame,
the structure being characterized in that:
the structure includes at least one differentially-stiff carbon fiber tube that is differentially stiff with regard to bending and to twisting.

12. The seat stay-chain stay structure set forth in claim 11 wherein:
the at least one differentially stiff carbon fiber tube is made using a lay-up which gives greater stiffness with regard to bending than with regard to twisting.

13. The seat stay-chain stay structure set forth in claim 11 wherein:
the seat stay-chain stay structure includes dual seat stays; and
both the dual seat stays and the chain stays are made of carbon fiber tubes that are stiffer with regard to bending than with regard to twisting.

14. The seat stay-chain stay structure set forth in claim 13 wherein:
the dual seat stays and the chain stays are made using lay-ups which give greater stiffness with regard to bending than with regard to twisting.

15. The seat stay-chain stay structure set forth in claim 11 wherein:
the seat stay-chain stay structure includes a wishbone seat stay; and
the chain stays are carbon fiber tubes made using lay-ups which give greater stiffness with regard to bending than with regard to twisting.

16. The seat stay-chain stay structure set forth in claim 15 wherein:
the handle of the wishbone seat stay is a carbon fiber tube with a cross section which is greater in the horizontal direction than in the vertical direction.

17. A method of making lugs for joints in a bicycle frame made of carbon fiber tubes, the method comprising the steps of:
making a lay-up of at least carbon fibers and a matrix material around the joint,
applying a mold to the tubes and laid-up fibers and matrix material, and
curing the lug in the mold, the cure including expansion of an element enclosed by the mold.

18. The method set forth in claim 17 wherein:
the mold is a captured silicon mold; and
in the step of curing the lug in the mold, the cure includes expansion of the captured silicon.

19. The method set forth in claim 17 wherein:
the step of making the lay-up includes the step of including a layer of expanding foam in the lay-up; and
in the step of curing the lug in the mold, the cure includes expansion of the foam.

20. The method set forth in claim 17 wherein:
the step of making a lay-up includes the steps of:
wrapping each tube in the joint with a first carbon fiber fabric that is impregnated with the matrix material, the ends of the fabric extending beyond the tube;
wrapping the ends of the carbon fiber fabric that is wrapped around a given tube around the tube the given tube joins to;
wrapping the entire joint in a second carbon fiber fabric whose fibers have an orientation different from that of the fibers in the first carbon fiber fabric.

21. The method set forth in claim 20 wherein:
the step of making a lay-up further includes the step of:
including a layer of expanding foam in the lay-up.

22. The method set forth in claim 21 wherein:
the step of including a layer of expanding foam is performed before the step of wrapping the entire joint in a second carbon fiber fabric.

23. The method set forth in claim 20 wherein:
the step of wrapping the entire joint is done such that all seams in the second carbon fiber fabric are at the top and bottom of the tubes and the second carbon fiber fabric is overlapped at the seams.
